(19) United States
(12) Patent Application Publication
(10) Pub. No.: US 2005/0229358 A1
(43) Pub. Date: Oct. 20, 2005

(54) Door stop

(76) Inventor: Neil Barone, Rumson, NJ (US)

Correspondence Address: Connolly Bove Lodge & Hutz LLP, P.O. Box 2207, Wilmington, DE, 19899-2207, US

(21) Appl. No.: 10/826,931

(22) Filed: Apr. 16, 2004

(51) Int. Cl. E05F 5/02

(52) U.S. Cl. 16/82

(57) ABSTRACT

A door stop is in the form of a generally U-shaped base having a spacing member extending outwardly from one of the vertical walls of the base. The door stop is slidably mounted on the bottom of a door. The spacing member is of a length greater than the distance a doorknob or other door hardware extends from the door. As a result, when the door is swung to its open position the spacing member contacts the room wall to prevent the door hardware from contacting the room wall. A magnet could be mounted to the wall molding to magnetically hold the door in its open position where at least part of the door stop is made of metal.

### BACKGROUND OF THE INVENTION

Most household doors and doors in buildings and offices are swingably mounted on hinges along one vertical end of the door. Commonly, such doors include various types of door hardware, such as doorknobs, which extend outwardly from the sides of the door. A problem exists when the hardware, such as the doorknob, would be pushed into contact with the wall of the room, which could result in damage to the room wall. Various techniques have been used in order to limit the extent that a door could be swung open, particularly, various types of door stops have been used. A traditional approach is to mount a door stop in the wall of a room extending outwardly a sufficient amount so that it is contacted by the swinging door before the doorknob or other hardware makes contact with the room wall. Such door stops are generally screwed or otherwise fastened to the wall or wall molding. Another approach is to mount a doorstop on a hinge of the door to limit the extent that the door can be swung. The various traditional doorstops are difficult to install, require tools, such as scewdrivers, wrenches and even power drills and still often result in damage to the walls or doors when they are installed by the making of screw holes. In addition, particularly when there is faulty installation the doorstops fall off after continued use.

### SUMMARY OF THE INVENTION

An object of this invention is to provide a doorstop which would be mounted directly on the door in a simple and convenient manner without requiring tools for its installation.

A further object of this invention is to provide such a door stop which could have the added function of keeping the door open once the door is swung to its open position.

In accordance with this invention the door stop is in the form of a generally U-shaped base having a pair of upwardly extending vertical walls interconnected by a bottom wall. The base could be mounted to the bottom edge of the door by simply being inserted around the bottom edge. A spacing member extends outwardly from one of the vertical walls of the base toward the room wall. One end of the spacing member is secured to one of the vertical walls of the base while the free end would be disposed remote from that vertical wall and toward the room wall during the swinging action. A contact tip is provided at the free end to contact the room wall or molding without causing damage. The length of the spacing member is greater than the length or extension of the door hardware, such as the doorknobs so that when the contact tip reaches the room wall the door hardware is spaced from and out of contact with the room wall thereby avoiding any damage.

The contact tip may be made of a material having magnetic attraction and could be used in conjunction with a magnet mounted to the room wall or molding. As a result, when the door is pushed to its open position the door is held in that open position through the magnetic attraction of the contact tip to the magnet.

The contact tip could be made of a cushioned material such as rubber or foam which could be snapped onto the spacing member. The U-shaped base could include at least one resilient wall bowed inwardly toward the other wall so that the U-shaped base could be conveniently mounted on the bottom of the door and remain in that mounted position as a result of the resilient spaced wall(s).

### THE DRAWINGS

FIG. 1 is a side elevational view of a door stop mounted on a door in accordance with this invention;

FIG. 2 is a front elevational view of the door stop shown in FIG. 1;

FIG. 3 is a bottom plan view of the door stop shown in FIGS. 1-2; and

FIG. 4 is a side elevational view of a modified door stop in accordance with this invention.

### DETAILED DESCRIPTION

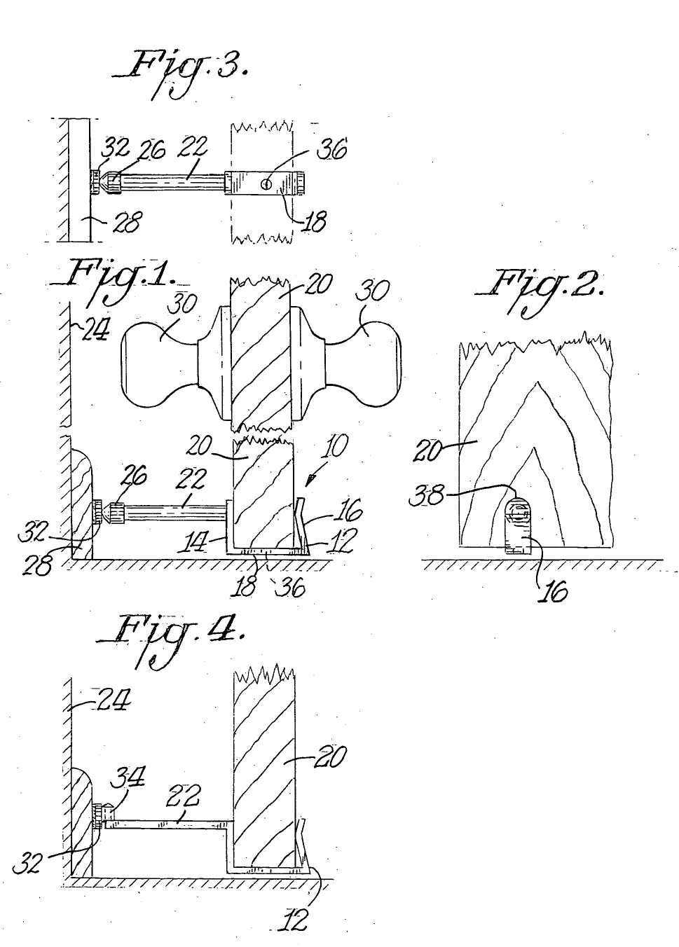

As shown in FIGS. 1-3 the door stop 10 includes a base 12 which is generally U-shaped. Base 12 has a pair of upwardly extending vertical walls 14,16 interconnected by a bottom wall 18. Preferably, at least one of the walls, such as wall 16, is made of a resilient material and is bowed inwardly toward the other wall 14 so that the distance between the two walls at the bowed in portion is less than the thickness of the door 20. Otherwise the spacing between walls 14 and 16 would preferably be at least slightly greater than the thickness of door 20. As a result, door stop 10 could be easily installed on door 20 by simply sliding the U-shaped base 12 along-the bottom of door 20 as illustrated in FIGS. 1 and 4.

Door stop 10 further includes a spacing member 22 which extends outwardly from vertical wall 14. One end of spacing member 22 is mounted to vertical wall 14 in any suitable manner. FIG. 1, for example, shows the anchored end to be welded to wall 14. FIG. 4 illustrates a variation wherein the spacing member 22 and base 12 are integral with each other. The free end of spacing member 22 would be disposed toward the room wall 24 when the door 20 is pushed to its open position. The free or remote end of spacing member 22 includes a contact tip 26 which would contact the wall 24 or, for example, wall molding 28.

Door 20 would include various door hardware such as doorknobs 30. Spacing member 22 is of a length which is greater than the distance that the door hardware extends from the door. As a result, when contact tip 26 is in contact with the room wall 24 or molding 28 the door hardware such as doorknob 30 remains spaced from and out of contact with room wall 24 thereby avoiding the possibility of damaging the room wall.

In a preferred practice of this invention a magnet 32 is secured to room wall 24 such as by the use of double sided adhesive tape or otherwise secured to the molding 28. Spacing member 22 and particularly its free end is made of a material such as a metal material which is capable of being magnetically attracted to magnet 32. Accordingly, when the door 20 is moved to its completely open position the door is held in that position through the magnetic attraction of spacing member 22 and magnet 32 thereby preventing accidental closing of the door due to structural deficiencies or wind or the like.

Door stop 20 may include various features. For example, contact tip 26 could be made of a rubber or foam material which could be snapped onto the metal free end of spacing member 22. If spacing member 22 is made of a non-magnetic material, such as plastic, contact tip 26 could be made of metal. Contact tip 26 could be of generally cylindrical shape having a pointed tip as illustrated in FIGS. 1-3 or could be an upward flat extension as indicated by the tip 34 in FIG. 4.

When the invention is practiced without the use of the magnet feature, contact tip 26 could be made of any suitable material, such as rubber. The free end of spacing member 22 could also function as the contact tip. Where the magnet feature is used, the contact tip could be the free end of the metal spacing member to provide a stronger magnetic attraction. Alternatively a non-metallic contact tip could be used and the magnetic attraction could come from the metallic spacing member. The invention could also be practiced with a non-metallic spacing member. If a magnet is used a metallic contact tip could be used for the magnetic attraction. If no magnet is used any type of contacting tip can be used, even the free end of the spacing member.

The door stop could be provided with a hole, such as hole 36 in bottom wall 18 to permit the door stop to be hung for painting. The hole 36 could be mounted at any other suitable location of stop 12. A further function of the hole 36 would be to permit the stop 10 to be hung during periods of non-use or for display purposes in a store.

In the preferred practice of the invention the U-shaped base 12 is in the form of a metal “U” hook having a rounded top 38 as shown in FIG. 2. Spacing member 22 is preferably a round metal rod. In order to readily mount the base 12 to the bottom of door 20 at least one of the vertical walls and possibly both could be made of a spring metal material. In the illustrated embodiment the outer vertical wall 16 is bowed inwardly at an intermediate portion between its top and bottom. When the door stop 10 is used with a standard interior door which is about 1⅜ inches wide, the maximum width between the walls 14 and 16 would be greater than the door width such as being 1 7/16 inches. The distance between the bowed in portion of wall 16 and the other vertical wall 14 would be less than the thickness of the door such as 1 5/16 inches. Any suitable height could be used for the base 12. The height should be sufficient to provide a firm mounting or installation on the door, but not be so great as to be unsightly by extending too far up the door. A height of about 1⅛ inches would be desirable. The width of base 12 could be of any suitable dimension such as ½ inches. Spacing member 22 could be of any suitable length such as 2⅞ inches, as long as it is longer than the extension of the door hardware 30. Where spacing member 22 is a round shaft it could have a ¼ inch diameter.

Preferably, the resilient bowed wall, such as wall 16, is bowed at an intermediate portion so that the upper exposed end extends outwardly to facilitate sliding the base 12 onto the door 20. The invention could, however, be practiced where the bowing is at the upper end, although this would require the wall 16 to be distended a sufficient distance to accommodate the thickness of door 20. Instead of or in addition to mounting a magnet on the room wall, the spacing member 22 could also include a magnet to assure maintaining the door in its open condition.

As is apparent the door stop 10 requires no tools for installation. Instead, the door stop simply slides around the bottom of the door and where a magnet is used the magnet could be either nailed or screwed into the wall or, more preferably, could be secured to the wall through the use of double-sided tape. This would prevent screw-hole damage to the door or wall and is easier to install than with conventional door stops.

1. A door stop for preventing door hardware on a pivotally mounted door from contacting a room wall when the door is swung to its open condition, said door stop comprising a base of generally U-shape with a pair of upwardly extending vertical walls interconnected by a bottom wall for fitting around and being mounted to the bottom of the door, a spacing member secured to one of said vertical walls and extending outwardly from said one vertical wall, said spacing member having an anchor end secured to said one vertical wall and a free end remote from said one vertical wall, and a contact tip at said free end.

2. The stop of claim 1 wherein said free end of said spacing member is capable of magnetic attraction to a magnet.

3. The stop of claim 1 wherein said contact tip is made of a cushioned material.

4. The stop of claim 3 wherein said contact tip is detachably snapped onto said free end.

5. The stop of claim 1 wherein said contact tip extends outwardly generally perpendicularly to said spacing member.

6. The stop of claim 1 wherein said one vertical wall is resilient.

7. The stop of claim 6 wherein said one vertical wall has an inwardly bowed portion.

8. The stop of claim 7 wherein said inwardly bowed portion is at an intermediate location of said one vertical wall.

9. The stop of claim 8 wherein the distance between said bowed portion and the other of said vertical walls is less than 1⅜ and the distance between said one vertical wall and said other vertical wall at another location of said base is greater than 1⅜.

10. The stop of claim 1 including a hole mounted in said base for permitting said stop to be hung during a period of non-use.

11. The stop of claim 10 wherein said hole is located in said bottom wall.

12. The stop of claim 1 wherein said base is made of a flat metal material and said spacing member is made of a round metal shaft welded to said base.

13. The stop of claim 1 wherein said base and said spacing member are integral with each other and made from a single metal piece.

14. The stop of claim 1 in combination with a door having sides and a bottom edge and with door hardware extending from at least one of said sides, and said base being mounted around said bottom edge.

15. The stop of claim 14 in further combination with a room wall, and a magnet mounted on said room wall in the path of motion of said spacing member.

16. The stop of claim 14 wherein said door hardware includes a doorknob spaced from said wall of said door a lesser distance than the length of said spacing member.

17. A method of preventing door hardware on a pivotally mounted door from contacting a room wall when the door is swung to an open condition, said method including slidably mounting a U-shaped base around the bottom of the door, providing a spacing member on one wall of the U-shaped base disposed toward the room wall with the spacing member having a length greater than the distance the door hardware extends from the door, and contacting the free end of the spacing member with the room wall when the door is swung open to prevent the door hardware from contacting the room wall.

18. The method of claim 17 including mounting a magnet to the room wall, and magnetically attracting and holding the spacing member against the magnet when the spacing member contacts the magnet.
